(19) United States
(12) Patent Application Publication
(10) Pub. No.: US 2023/0151287 A1
(43) Pub. Date: May 18, 2023

(54) GAS PRODUCTION FROM SOLIDS VIA NON-THERMAL PLASMA

(71) Applicant: University of Massachusetts, Boston, MA (US)

(72) Inventors: Juan Pablo Trelles, Sudbury, MA (US); Hsi-Wu Wong, Burlington, MA (US); John Hunter Mack, Arlington, MA (US)

(21) Appl. No.: 17/984,673

(22) Filed: Nov. 10, 2022

Related U.S. Application Data
(60) Provisional application No. 63/278,620, filed on Nov. 12, 2021.

(51) Int. Cl. C10J 3/72; B01J 19/08; C01B 3/02

(52) U.S. Cl. CPC C10J 3/72; B01J 19/088; C01B 3/02; B01J 2219/0896; B01J 2219/0809; B01J 2219/0869; B01J 2219/0879; C10J 2300/1238; C10J 2300/0946

(57) ABSTRACT

A first voltage source produces a first voltage such as an AC voltage. Further, a first electrode of a hydrogen generation system conveys the first voltage. The first voltage conveyed over the first electrode generates low-temperature plasma extending between the first electrode and the mass of material. Presence of the low-temperature plasma releases gas from the mass of material.

### RELATED APPLICATION

This application claims the benefit of earlier filed U.S. Provisional Patent Application Ser. No. 63/278,620 entitled “HYDROGEN PRODUCTION FROM SOLIDS VIA ATMOSPHERIC PRESSURE NON-THERMAL PLASMA,” (Attorney Docket No. UML2021-024-01P, filed on Nov. 12, 2022, the entire teachings of which are incorporated herein by this reference.

### GOVERNMENT SUPPORT

This invention was conceived under a contract with an agency of the United States Government. The name of the U.S. Government agency and Government contract number are: US Army Combat Capabilities Development Command (DEVCOM) Soldier Center Contracting Division through Contract #W911QY-20-2-0005.

### BACKGROUND

Plasma is one of the four fundamental states of matter. It includes a significant portion of charged particles—ions and/or electrons. Presence of the charged particles sets plasma apart from other fundamental states of matter such as solid, liquid, and gas. Plasma is typically a high-energy state of matter; the embodied energy causes the electrons to separate away from corresponding atoms, resulting in formation of an ionized gas.

Global energy demand is projected to increase by 56% by 2040, driven by population growth and industrialization, particularly in developing countries. Since fossil fuels are responsible for approximately 80% of global energy demands, greenhouse gas emissions and their adverse impacts are also expected to increase unless the production and use of alternative energy sources, such as green hydrogen, are scaled-up. Hydrogen not only has the highest energy density (120 MJ/kg) of all fuels on a mass basis, but it also does not produce CO₂, the most prominent greenhouse gas, when reacted with oxygen. Furthermore, hydrogen is one of the most abundant elements in the earth's crust. However, hydrogen does not occur naturally; instead, it is embedded in water, hydrocarbons, and solid compounds such as biomass and plastics.

The increasing global production of plastics, which was approximately 360 million tons in 2018, has led to a dramatic increase in plastic waste, polluting the environment and interfering with ecosystems. Incineration, the dominant approach to dispose of plastic, leads to CO2 emissions and is prone to emit volatile organic compounds deleterious to human health.

Conventional techniques of producing hydrogen from plastic waste are mainly divided between thermochemical and electrochemical methods.

In conventional thermochemical approaches, heat is supplied to plastic waste to attain high temperatures (typically over 1000 degrees Celsius) that promote desired chemical conversion reactions. This can either be done in the absence of oxygen via pyrolysis or in the presence of a controlled amount of oxygen through gasification. In electrochemical methods, plastic waste is converted directly or indirectly by reduction-oxidation reactions within electrochemical cells. Since both the electrolytes and electrodes require replenishing, conventional electrochemical methods are generally more expensive than thermochemical approaches. Even though thermochemical processes are widely used in plastic waste treatment, these processes typically depict low rates of hydrogen production, limited selectivity, and low energy efficiency due to energy spent in auxiliary functions, such as cooling of gas products.

### BRIEF DESCRIPTION OF EMBODIMENTS

Plasma, i.e., partially ionized gas constituted of free electrons and heavy-species (ions, atoms, and molecules), generated at (near) atmospheric pressure conditions is broadly classified as either thermal or non-thermal (i.e., low temperature). In thermal plasma, electrons and heavy-species are in thermal equilibrium and therefore depict the same temperature, usually ranging from 6000 K (Kelvin) to over 20,000 K. In contrast, in so-called nonthermal or low-temperature plasma, the temperature of free electrons is high (such as 1 electron-Volt, eV, approximately equivalent to 11,600 K, or higher) compared to the heavy-species temperature (e.g., a few hundred Celsius), resulting in a state of non-thermal equilibrium. Conventional plasma-based approaches for plastic waste treatment generally do not require oxidizing agents given the high reactivity of plasma species. Moreover, atmospheric pressure plasma processes often have compact footprints thanks to the high fluxes of reactive species. The application of thermal plasma to plastic waste treatment has been studied to a significant extent, even leading to the construction of pilot plants. The high energy density and high temperature of thermal plasma processes are desirable for applications such as thermal sprays, welding, plasma cutting, and solid waste treatment. However, for processes that require selective treatment of reactants with relatively low melting points, such as hydrogen production from plastics, high-temperature operations may be undesirable as they may lead to limited energy efficiency or complex installations.

Techniques for plastic waste treatment based on low-temperature and atmospheric pressure operation, such as nonthermal (low-temperature) plasma processes as discussed herein, have the potential to be more viable than conventional approaches. Moreover, if powered by renewable electricity (e.g., wind or solar photovoltaic power), plasma-based techniques would mitigate CO₂ emissions associated with plastic waste treatment.

More specifically, as discussed herein, an apparatus can be configured to include: a first voltage source operative to produce a first voltage; and a first electrode operative to convey the first voltage. The first voltage is conveyed over the first electrode is to generate low-temperature plasma applied to a mass of material. Presence of the low-temperature plasma generated by the electrodes causes release of gas from the mass of material. In one example, gas in a volume in which the low-temperature plasma (i.e., non-thermal plasma) resides is less than 2000 degrees Celsius; the temperature of the low temperature plasma itself as discussed herein is 1 to 10 electron-Volts). In comparison, conventional thermal plasma has a high gas temperature of 10,000 K or higher (such as between 10,000 and 20,000 K), which is close to the temperature of the free electrons of nearly 1 electron-Volts or higher.

The electrodes (such as circuit path, electrically conductive path, etc.) as discussed herein can be fabricated any suitable material such as metal and can take any suitable shape or size, providing conveyance of a respective voltage to a desired location.

In a further example, the apparatus as discussed herein includes: i) a second electrode operative to convey a reference voltage associated with the first voltage; and ii) a retainer to retain the mass of material. The second electrode conveys the reference voltage to the retainer.

In yet a further example, an axial end of the first electrode includes a pointed tip from which the low-temperature plasma extends from the pointed tip at the axial end of the first electrode to a surface of the mass material.

The mass of material can be any suitable material. In one example, the mass of material is a solid polymer material. The gas released from the mass of material can be any suitable gas. In one example, the gas released from the mass material is hydrogen gas.

The apparatus as described herein can be further configured to include an airtight container in which the first electrode and the mass of material reside. The container contains emitted hydrogen gas. The airtight container includes an input port and an output port, the input port can be configured to input a first gas into the airtight container, the output port can be configured to exhaust a second gas, including the hydrogen gas, from the airtight container.

In a yet further example, the apparatus as described herein can be configured to include a second voltage source operable to produce a second voltage as well as a second electrode operative to convey the second voltage. In such an instance, a combination of the first voltage conveyed over the first electrode and the second voltage conveyed over the second electrode are operative to generate the low-temperature plasma; the low- temperature plasma extends between at least the first electrode and the second electrode to the mass of material.

Yet further, the apparatus can be configured to include: i) a nozzle operative to supply gas directed towards the low-temperature plasma; the supplied gas causes contact of the low-temperature plasma to a surface of the mass of material; ii) a third electrode operative to convey a reference voltage associated with the first voltage and the second voltage; and iii) a retainer to retain the mass of material, the first electrode and the second electrode diverging from each other as axial ends of the first electrode and the second electrode become nearer to the mass of material.

In a still further example, the apparatus includes: a container (chamber) in which the first electrode, the second electrode and the mass of material reside, the container containing the gas released from the mass of material. The container can be configured to include an input port and an output port. In such an instance, the input port is operative to input first gas into the container, the output port operative to exhaust a second gas from the container. The second gas includes a combination of the first gas and the gas released from the mass of material.

In further example embodiments, the mass of material includes a non-homogenous mixture or combination of multiple different types of material. In one embodiment, each of the multiple different types of material in the mass of material produces the gas released from the mass of material when exposed to the low temperature plasma.

Further examples as discussed herein include a method comprising: producing a first voltage via a first voltage source, the first voltage conveyed over a first electrode; and via conveyance of the first voltage over the first electrode, generating low-temperature plasma applied to a mass of material; presence of the low-temperature plasma causes release of gas from the mass of material.

The method as discussed herein can be configured to further retain, via a retainer, the mass of material and apply a reference voltage over a second electrode to the retainer, the reference voltage being a return path associated with the first voltage.

As previously discussed, an axial end of the first electrode can be configured to include a pointed tip from which the low-temperature plasma extends from the pointed tip at the axial end of the first electrode to a surface of the mass of material.

In a still further example, the method as discussed herein includes: containing the gas in a container in which the first electrode and the mass of material reside. The gas released from the mass of material is a first gas; the container includes an input port and an output port. In such an instance the method further includes: via the input port, input a second gas into the container; via the output port, exhaust a third gas from the container, the third gas including the first gas and the second gas.

The method as discussed herein can include further operations such as: via a second voltage source, producing a second voltage; via a second electrode, conveying the second voltage; and generating the low-temperature plasma via a combination of the first voltage conveyed over the first electrode and the second voltage conveyed over the second electrode, the low-temperature plasma extending between at least the first electrode and the second electrode to the mass of material. The gas released from the mass of material is a first gas. The method further includes, via a nozzle, supplying second gas directed towards the low-temperature plasma, the supplied second gas causing the low-temperature plasma to contact a surface of the mass of material.

Still further examples herein include, via a third electrode, conveying a reference voltage associated with the first voltage and the second voltage; and via a retainer, retaining the mass of material. The first electrode, the second electrode, and the third electrode can be configured to diverge from each other as axial ends of the first electrode, the second electrode, and the third electrode become nearer to the mass of material.

Approaches based on non-thermal or low-temperature plasma as discussed herein potentially have greater energy efficiency and selectivity than thermal plasma processes.

Furthermore, non-thermal plasma processes operating at atmospheric pressure as discussed herein are highly desirable due to potentially lower capital and operating expenses (e.g., no need for vacuum systems) and compatibility with other unit operations.

These and further embodiments are discussed below.

Note that any of the resources as discussed herein can include one or more computerized devices, fabrication equipment, mobile communication devices, wireless communication devices, gateway resources, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out or control operations associated with the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to support wireless communications, image processing, image capturing, etc., according to embodiments herein. The instructions, when executed by the computer processor hardware, cause the computer processor hardware (such as one or more co-located or disparately processor devices or hardware) to: produce a first voltage via a first voltage source, the first voltage conveyed over a first electrode; and via conveyance of the first voltage over the first electrode, generate low-temperature plasma applied to a mass of material, presence of the low-temperature plasma releasing gas from the mass of material.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of conveying wireless communications in wireless network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1A is an example 3-D diagram illustrating a first hydrogen gas generator system as discussed herein.

FIG. 1B is an example side cross-section view diagram illustrating a first hydrogen gas generator system as discussed herein.

FIG. 1C is an example 3-D diagram illustrating a cutaway view of a first hydrogen gas generator system as discussed herein.

FIG. 2A is an example 3-D diagram illustrating a second hydrogen gas generator system as discussed herein.

FIG. 2B is an example side cross-section view diagram illustrating a second hydrogen gas generator system as discussed herein.

FIG. 2C is an example 3-D diagram illustrating a cutaway view of a second hydrogen gas generator system as discussed herein.

FIG. 3 is a diagram illustrating chemical attributes of an example mass of solid material (such as organic material, inorganic material, polymer material, etc.) and at least partial conversion to hydrogen gas as discussed herein.

FIG. 4 is an example diagram of average surface temperature of the material versus dissipated thermal power for two flow rates associated with a first reactor system as described herein.

FIG. 5 is an example diagram of average surface temperature of the material versus dissipated thermal power for two flow rates associated with a second reactor system as described herein.

FIG. 6 is an example diagram of average surface heat flux versus dissipated thermal power for two flow rates associated with a first reactor system as described herein.

FIG. 7 is an example diagram of average surface heat flux versus dissipated thermal power for two flow rates associated with a second reactor system as described herein.

FIG. 8 is an example diagram illustrating hydrogen gas production rate from different materials versus time as described herein.

FIG. 9 is an example diagram illustrating hydrogen gas production energy efficiency from different materials versus time as described herein.

FIG. 10 is an example diagram illustrating hydrogen gas production rate versus mixture ratio of a polymer such as LDPE (Low Density Polyethylene) versus another polymer such as Cellulose as discussed herein.

FIG. 11 is an example diagram illustrating hydrogen gas production energy efficiency versus mixture ratio of LDPE (Low Density Polyethylene) versus Cellulose as discussed herein.

FIG. 12 is an example diagram of a computer architecture executing software instructions according to embodiments herein.

FIG. 13 is an example diagram illustrating example methods according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

Embodiments herein include hydrogen production from a mass of material such as including low-density polyethylene (LDPE) using non-thermal atmospheric pressure plasma. In addition to hydrogen, other co-products such as methane, ethylene, ethyne, propane, and larger molecular hydrocarbons have been reported from the processing of similar organic polymeric feedstock, such as high-density polyethylene (HDPE), polyethylene, and polypropylene. This disclosure includes, among other things, a focus on the design and characterization of plasma reactors for the production of, for example, hydrogen from, for example, LDPE and other materials, and therefore hydrogen is treated as the main product. LDPE and other materials comprise long hydrocarbon chains with short branches, usually between 0.5 and 1 million carbon units. It is widely used for packaging, thin-film coatings, pipes, and cable production and is a primary component of global plastic waste. Embodiments herein envision valorizing plastic waste or other material via the direct use of renewable electricity at atmospheric pressure and low temperature conditions (such as gas temperature of less than 2000 degrees Celsius) and with minimal or no auxiliary reactants. This disclosure further presents the design of two non-thermal atmospheric pressure (or operated in pressure between 10 and 20 pounds per square inch) plasma reactors to produce hydrogen from a mass of polymer material.

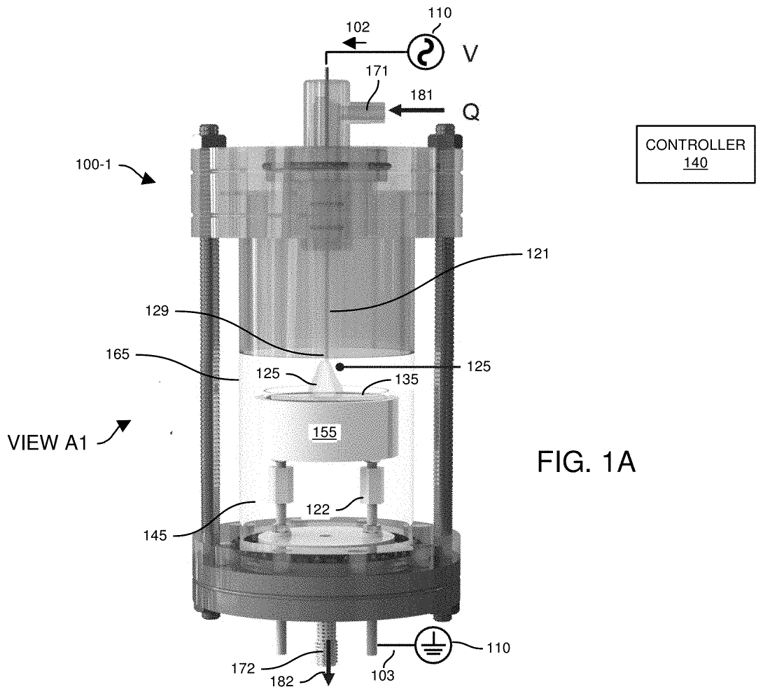

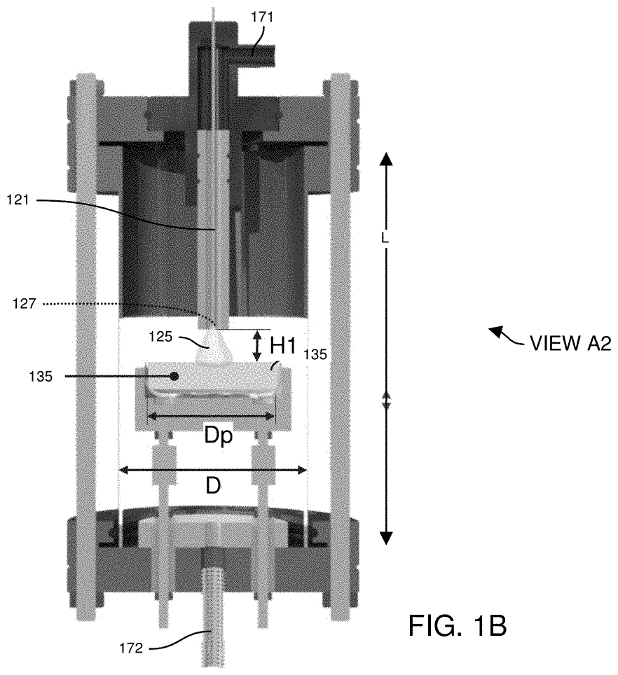

Now, with reference to the drawings, FIG. 1A is an example 3-D diagram illustrating a first gas generator system as discussed herein. FIG. 1B is an example side cross-sectional view diagram illustrating the first gas generator system as discussed herein. FIG. 1C is an example diagram illustrating a cutaway view of the first gas generator system as discussed herein.

With reference to system 100-1 in FIGS. 1A, 1B, and 1C, view A1 is a 3-D view of system 100-1; view A2 in FIG. 1B is a side cross-sectional view of the system 100-1; view A3 in FIG. 1C is a 3-D cutaway view of the system 100-1.

As shown in the FIGS. 1A, 1B, and 1C, system 100-1 can be configured to include controller 140. The controller controls the system 100-1 such as operation of the first voltage source 110 to produce a first voltage 102 such as an AC voltage (such as a magnitude between 1,000 and 40,000 V AC). Further, a first electrode 121 of the system 100-1 conveys the first voltage 102 from the source 110 to the tip 129 of the electrode 121. The first voltage 102 conveyed over the first electrode 121 generates low-temperature plasma 125 extending between the tip 129 (such as pointed tip) of the first electrode 121 and the mass of material 135.

Presence and/or application of the low-temperature plasma 125 of the mass of material 135 releases a gas 145 such as hydrogen or other gas from the mass of material 135 (such as a solid polymer material).

Note that the mass of material 135 can include any suitable one or more different types of material. For example, the mass of material 135 may include one or more types of matter such as LDPE, cellulose, etc. Accordingly, the mass material 135 may include an organic polymer (such as cellulose) and another organic polymer (such as LDPE). If the mass of material 135 is fabricated to include a mixture of different matter, the ratio of the different types of material in the mass of material 135 may vary. For example, in one non-limiting example embodiment, the ratio may include LDPE and cellulose at a ratio of 1:1 or other suitable value.

Thus, in one embodiment, the mass of material 135 may be a homogeneous material of single type of polymer or other suitable type of material. Alternatively, the mass of material 135 may be an inhomogeneous material of multiple different types of polymer material or non-polymer material. In one embodiment, each of the multiple different types of material in the non-homogeneous mass of material produces the gas released from the mass of material when exposed to the plasma 125. Further, note that in certain instances, implementation of a mixture of different types of material as the mass of material 135 provides a synergistic affect, resulting in a higher yield of generated gas 145 (target gas such as hydrogen or other matter).

Note that any of the electrodes as discussed herein can take any shape, from, size, etc. In general, each of the electrodes as discussed herein can be basically any suitable component or element from which to generate and/or output a respective voltage to create low temperature plasma as discussed herein. Thus, the electrodes (such as circuit path, electrically conductive path, etc.) as discussed herein can be fabricated from any suitable material such as metal and can take any suitable shape or size, providing conveyance of a respective voltage to a desired location with respect to the mass of material 135.

In further example embodiments, the system 100-1 includes a second electrode 122 that conveys a reference voltage 103 (such as ground) associated with the first voltage 102. As further shown, the system 100-1 includes a metal retainer 155 to retain the mass of material 135. The mass material 135 is in contact with the metal retainer 155. The second electrode 122 conveys the reference voltage 103 to the retainer 155 and mass of material 135 therein. The mass material 135 is encompassed by the retainer 155 in which a top surface of the mass of material 135 is exposed to the low-temperature plasma 125.

In still further example embodiments, as previously discussed, an axial end of the first electrode 121 includes a tip 129 (such as axial end) from which the low-temperature plasma 125 extends from the pointed tip 129 at the axial end or other portion of the first electrode 121 along its length to an exposed surface of the mass of material 135. The container 165 (such as an airtight or non-airtight chamber including glass in which the first electrode 121 and the mass of material 135 reside) contains the generated gas 145 (such as hydrogen gas) as it is released from the mass of material 135.

The tip 129 can take any suitable shape such as a pointed tip, a flat tip, a rounded tip, etc.

Note that a volume and/or shape of the low temperature plasma 125 may change over time. In one embodiment, the low temperature plasma 125 extends between the axial end or sides of the electrode 121 and a corresponding exposed top surface of the mass material 135. In one example, the low temperature plasma 125 resides in a changing volume; a temperature of the gas in that volume in which the low-temperature plasma resides is less than 2000 degrees Celsius; the temperature of the electrons in the low-temperature plasma 125 is 1-10 electron-Volts. Note that, in a non-thermal or low temperature plasma, it may not be considered appropriate to refer to a single temperature. Instead, we refer to the heavy-species (gas) temperature (<2000 degrees Celsius) and the electron-temperature (1-10 electronvolt)

In one embodiment, the temperature of the gas in the chamber and gas in which the low-temperature plasma 125 resides is higher than room temperature such as between 2 and 30 degrees Celsius. As a further example, a temperature of the inflow gas Q (a.k.a., gas 181) may be room temperature (e.g. 2 to 30 degrees Celsius). The temperature of the heavy-species within the plasma may be <2000 degrees Celsius. The temperature of the gas (such as gas 145) within the container 165 is somewhere in between, e.g., 50 to 300 degrees Celsius, although the temperature of the gas 145 may fall outside of this range.

Thus, the low temperature plasma 125 can be considered to have two temperatures: a first temperature of the gas in which the low temperature plasma 125 resides (a temperature such as less than 2000 degrees Celsius, less than 1000 degrees Celsius, less than 500 degrees Celsius, less than 200 degrees Celsius, less than 100 degrees Celsius, less than 50 degrees Celsius, and so on) and a second temperature (such as 1-10 electron-Volts) of electrons in the low temperature plasma itself.

In yet further example embodiments, the container 165 includes an input port 171 and an output port 172. The input port 171 inputs first gas 181 (such as one or more of air, inert gas, oxygen, working gas, dilutant gas, etc.) into the container 165 (chamber); the output port 172 exhausts a second gas 182 from the container 165. In one embodiment, the gas 181 is inputted to the chamber (container 165) passes through the nozzle 127 (FIG. 1B and FIG. 1C). In one embodiment, the gas 181 envelops (i.e., surrounds) the axial end (tip 129) of the electrode 121 is the gas 181 as it is inputted to the container 165 through the nozzle 127 (FIG. 1B).

In one embodiment, the second gas 182 includes the gas 181 and the generated gas 145. In another example embodiment, the hydrogen gas reacts with the first gas (such as including oxygen) and produces water or some other matter.

As further shown, the system 100-1 outputs the gas 182 from the output port 172.

In one implementation, hydrogen gas (such as released gas 145) present in the container 165 could be combined with oxygen in the container 165, for example if air is used as working gas 281; this could form water on the spot, as a product.

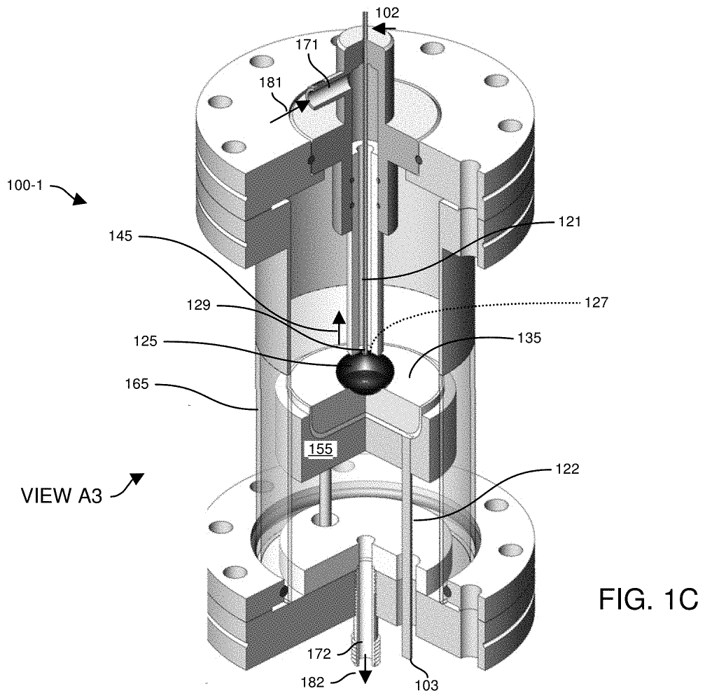

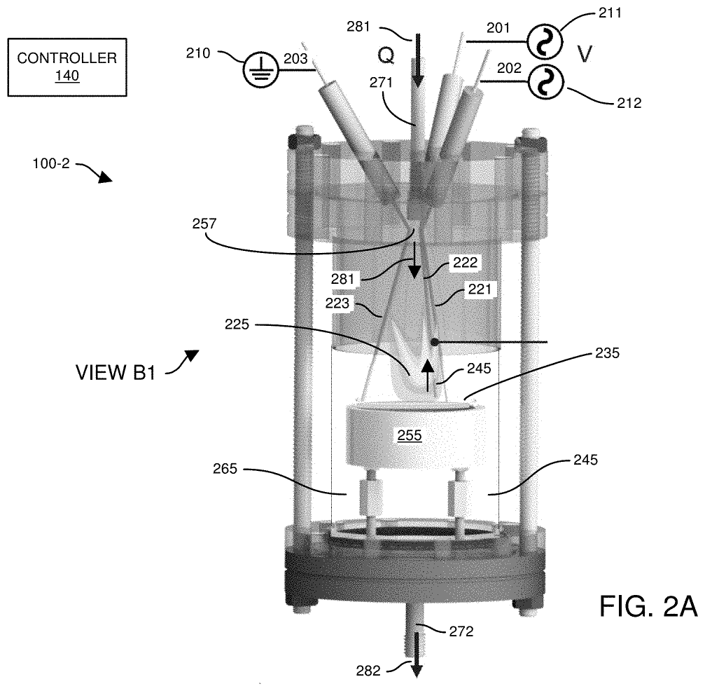

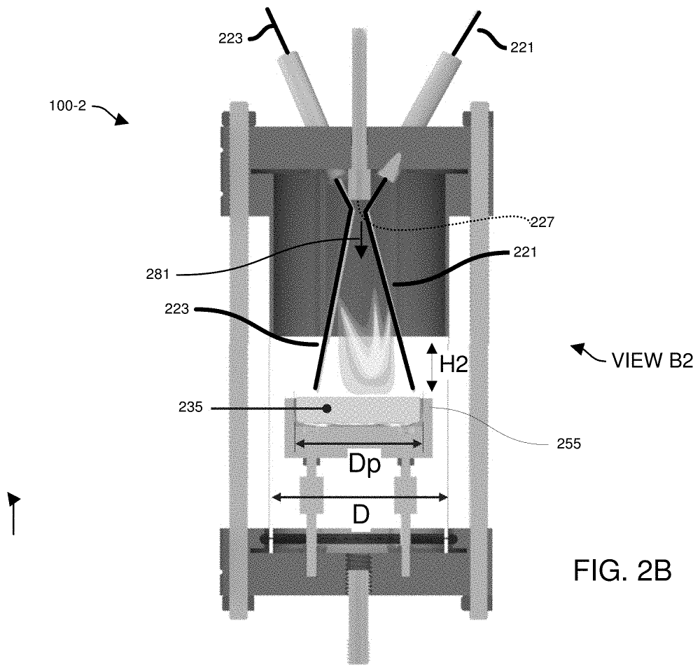

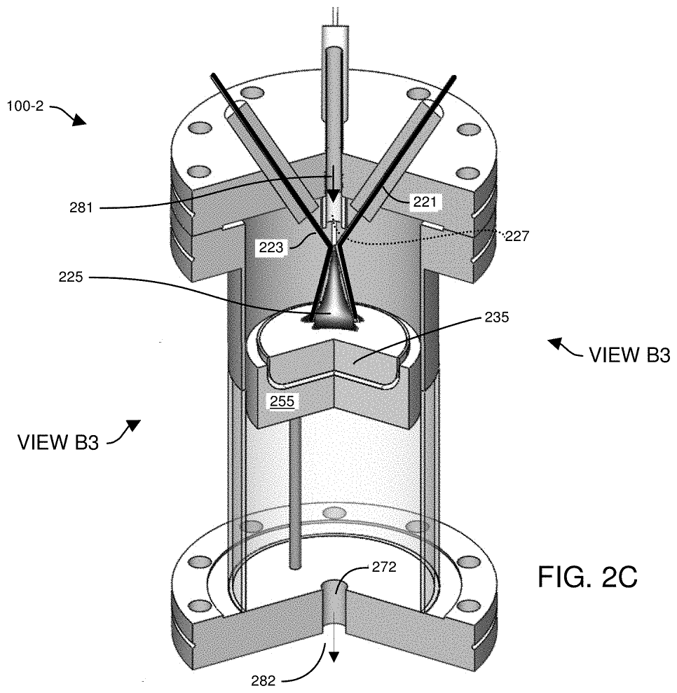

FIG. 2A is an example 3-D diagram illustrating a second gas generator system as discussed herein. FIG. 2B is an example side cross-sectional view diagram illustrating a second gas generator system as discussed herein. FIG. 2C is an example diagram illustrating a cutaway view of a second gas generator system as discussed herein.

With reference to system 100-2 in FIG. 2A, FIG. 2B, and FIG. 2C, view B1 is a side cross-sectional view of system 100-2; view B2 is a 3-D cross-sectional view of the system 100-2; view B3 is a cutaway view of the system 100-2.

In one embodiment, controller 140 controls operation of the system 100-2 including a first voltage source 211 and a second voltage source 212. Based on control, the first voltage source 211 produces a first voltage 201 such as an AC voltage (such as a magnitude between 1,000 and 40,000 VAC or any other suitable AC voltage). A second voltage source 212 produces the second voltage 202 such as an AC voltage (such as a magnitude between 1,000 and 40,000 VAC or any other suitable AC voltage). The voltage 201 and voltage 202 may be in phase or out of phase with respect to each other.

The first electrode 221 of the system 100-2 conveys the first voltage 201. The second electrode 222 conveys the second voltage 202. A third electrode 223 of system 100-2 conveys a reference voltage 203 (from ground reference voltage source 210) associated with the first voltage 201 and the second voltage 202.

The combination of the first voltage 201 conveyed over the first electrode 221 and the second voltage 202 conveyed over the second electrode 222 (with respect to the ground reference voltage 203 conveyed by electrode 223) generates the low-temperature plasma 225. The low-temperature plasma 225 extends between one or more of the first electrode 221, the second electrode 222, and third electrode 223 to a surface of the mass of material 235 (such as a solid polymer material or other suitable matter). Note that the system 100-2 can be configured to include any number of voltage sources and corresponding electrodes to generate the plasma 225.

In a similar manner as previously discussed, the presence of the low-temperature plasma 225 releases gas from the mass of material 235 such as hydrogen gas 245.

In a similar manner as previously discussed, note that the mass of material 235 can include any suitable one or more different types of material. For example, the mass of material 235 may include one or more types of matter such as LDPE, cellulose, etc. Accordingly, the mass material 235 may include an organic polymer (such as cellulose) and another organic polymer (such as LDPE). If the mass of material 235 is fabricated to include a mixture of different matter, the ratio of the different types of material in the mass of material 235 may vary. For example, in one non-limiting example embodiment., the ratio may include LDPE and cellulose at a ratio of 1:1 or other suitable value.

Thus, in one embodiment, the mass of material 235 may be a homogeneous material of single type of polymer or other suitable type of material. Alternatively, the mass of material 235 may be an inhomogeneous material of multiple different types of polymer material or non-polymer material. In one embodiment, each of the multiple different types of material in the non-homogeneous mass of material produces the gas released from the mass of material when exposed to the plasma 225. Further, note that in certain instances, implementation of a mixture of different types of material as the mass of material 235 provides a synergistic affect, resulting in a higher yield of generated gas 245 (target gas such as hydrogen or other matter).

A nozzle 257 of the system 100-2 supplies first gas 281 (such as one or more of air, inert gas, working gas, dilutant gas, etc.) directed towards the low-temperature plasma 225 in container 265 (a.k.a., chamber). In one embodiment, the supplied gas 281 causes or at least aids in contact of the low-temperature plasma 225 to a surface of the mass of material 235 and release of gas 245 such as hydrogen.

Note that a volume and/or shape of the low temperature plasma 225 may change over time. In one embodiment, the low temperature plasma 225 extends between the axial ends or sides of the electrodes 221, 222, and 223 and a corresponding exposed surface of the mass material 235. In one example, the low temperature plasma 225 resides in a changing volume; a gas temperature of the volume in which the low temperature plasma 225 resides is less than a temperature of 2000 degrees Celsius or other suitable value such as below 1000 degree Celsius, below 500 degrees Celsius, below 200 degrees Celsius, below 100 degrees Celsius, below 50 degrees Celsius, or any suitable value; the temperature of the low temperature plasma itself 125 is 1-10 electron-Volts. In one embodiment, the temperature of the gas in the chamber and gas in which the low temperature plasma 225 is created is room temperature such as between 2 and 30 degrees Celsius. In another example, the temperature of the gas in the chamber and gas in which the low temperature plasma 225 is created is less than 100 degrees Celsius.

Thus, the low temperature plasma 225 can be considered to have two temperatures: a first temperature of the gas in which the low temperature plasma 225 resides (such as less than 2000 degrees Celsius, less than 1000 degrees Celsius, less than 500 degrees Celsius, less than 200 degree Celsius, less than 100 degrees Celsius, less than 50 degrees Celsius, and so on) and a second temperature (such as 1-10 electron-Volts) of electrons in the low temperature plasma 225 itself.

System 100-2 further includes a retainer 255 to retain and provide physical contact the mass of material 235. As shown, the first electrode 221, second electrode 222, and the third electrode 223 initially extend towards each other but then diverge from each other as axial ends of the first electrode 221, second electrode 222, and the third electrode 223 are nearer to the mass of material 235.

As further shown, the container 265 (in which the first electrode 221, the second electrode 222, the third electrode 223, and the mass of material 235 reside) contains the gas 245 generated from the mass of material 235.

As previously discussed, the container 265 includes an input port 271 and an output port 272. The input port 271 inputs first gas 281 (such as one or more of air, inert gas, oxygen, working gas, dilutant gas, etc.) through nozzle 257 into the container 265 and center of electrodes 221, 222, and 223. In one embodiment, the gas 281 is inputted to a chamber (container 265) at the nozzle 227 (FIG. 2B and FIG. 2C). The gas 281 is optionally inputted in a center of the multiple electrodes 221, 222, 223 as they diverge.

The output port 272 exhausts the second gas 282 from the container 265. In one embodiment, the second gas 282 includes a mixture of the gas 245 as well as the gas 281. In another example embodiment, the gas 145 may react with the gas 281 (such as including oxygen) to produce matter such as and produces water. More specifically, in one implementation, hydrogen gas (such as released gas 145) could be combined with oxygen, for example if air is used as working gas 281; this could form water on the spot, as a product.

Note that the gas generation systems 100-1, 100-2, etc., as discussed herein can be implemented for batch as well as continuous processes. For example, embodiments herein can include a continuous process such as continuously feeding of fresh solid material such as mass of material 135 and removal of treated portions of that mass of material 135 to provide generation of the respective gas 145.

Note further that each of the different reactor systems as discussed herein can be operated in any orientation. The implementations as discussed herein use vertical orientation (e.g., vertical placement of electrodes and gas flow from top to bottom). Nevertheless, implementing the systems as discussed herein can include varying and orientation of the components such as mass of material 135, electrodes, chamber 165, etc.

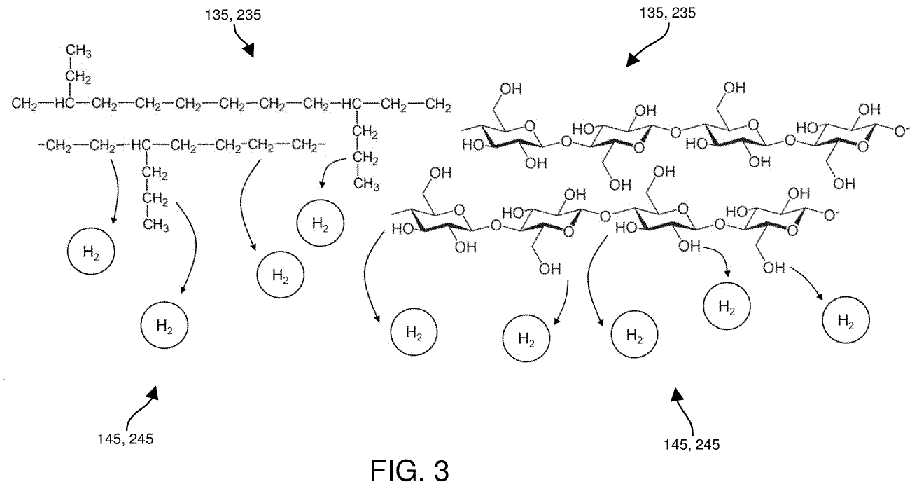

FIG. 3 is a diagram illustrating chemical attributes of an example mass of solid material (such as organic material, inorganic material, etc.) and conversion to hydrogen gas as discussed herein.

In this example, the FIG. 3 illustrates generation of gas 145, 245 such as hydrogen gas via exposure of the low temperature plasma 125, 225 to the mass of material 135, 235. Additional details of the system 100-2 are discussed below. The mass of materials 135, 235 can include one or more different chains of hydrogen (H), carbon (C), and arbitrary (A) atoms (such as nitrogen N, oxygen O, etc.), not only as linear, but also with bifurcations and ramifications.

As previously discussed, hydrogen gas can be produced via natural gas reforming or electrochemical water-splitting, leaving organic solid feedstocks under-utilized. Plasma technology powered by renewable electricity can lead to the sustainable upcycling of plastic waste and production of green hydrogen. As discussed herein, low-temperature atmospheric pressure plasma reactors based on transferred arc (so-called transarc in FIGS. 1A, 1B, and 1C) and gliding arc (so-called glidarc in FIGS. 2A, 2B, and 2C) discharges are designed, built, and characterized to produce hydrogen from a mass of material such as low-density polyethylene (LDPE) as a model plastic waste. Experimental results show that hydrogen production rate and efficiency increase monotonically with increasing input voltage levels in both reactors. Note that the low temperature plasma 125 and 225 as discussed herein does not need to be an “arc” (transarc is just a name for transferred-current arc); the plasma 125 and 125 may be a “glow”, “spark” or other type of “electrical discharge”.

For the transarc reactor (system 100-1), smaller electrode-feedstock spacing favors greater hydrogen production, whereas, for the glidarc reactor (system 100-2), greater hydrogen production is obtained at intermediate flow rates. The hydrogen production rate per unit power from mass of material such as LDPE is comparable despite the markedly different modes of operation between the two reactors.

Thus, two reactors (system 100-1 and system 100-2) are disclosed for hydrogen production from atmospheric nonthermal plasma (such as low-temperature plasma 125). The reactors are based on transferred-current plasma (transarc or system 100-1) and gliding arc (glidarc or system 100-2) electrical discharges, and present complementary operational characteristics.

The transarc reactor (FIGS. 1A, 1B, and 1C) can be configured to include a pin-to-plate configuration with a powered tungsten electrode placed perpendicularly above an aluminum disc, which acts as the ground electrode and support of the crucible (155, 255) holding the mass of material 135, 235 such as solid feedstock (LDPE sample). The name transferred arc stems from electric current being transferred from the one or more powered electrodes to the mass of material 135, 235 (a.k.a., feedstock). Thus, the feedstock is electrically coupled to the generated low temperature plasma 125. The generated low temperature plasma 125 and 225 as discussed herein does not need to correspond to arc discharge plasma; it could be a glow discharge, a spark discharge, a corona discharge, or another type of plasma due to the transfer of electric current to the workpiece (processing matter such as mass of material 135 and 235). The distance between the tip of the one or more powered electrodes and the upper exposed surface of the mass of material 135, 235, denoted as H1, H2, is used as a control parameter. The gas nozzle can be configured from high-temperature resin fitted with a ceramic (alumina) bushing.

The glidarc reactor can be configured to include a tri-prong equally spaced tungsten electrodes (221, 222, 223) diverging and with a gliding length of 30 mm. This electrode configuration generates a Y-shaped gliding arc (such as low temperature plasma 235) at the minimum inter-electrode separation distance. Two electrodes (221 and 222) are powered by a separate power supply (201 and 202) and the third electrode (223) is set as ground 210. The name gliding arc stems from the fact that the generated arc glides along the electrodes due to the combined effects of advection of the gas inflow and the buoyancy of the low-density plasma. In one embodiment, the minimum inter-electrode separation of electrodes 221 and 222 is 5 millimeters. The glidarc plasma (low temperature plasma 125) is electrically decoupled from the feedstock (such as mass of material 235), making it suitable for treating a continuous stream of feedstock and surfaces.

Both reactors can be powered by high voltage alternating current (AC) power supplies 201 and 202, delivering up to or more than 300 Watts of output power with an independent AC voltage frequency control from 20 to 70 kHz. The power supplies 201 and 202 can be voltage-controlled by setting the voltage level (V) from 0 to 100%, leading to a maximum voltage output (for zero load) from 1 to 40 kV. In further example embodiments, Nitrogen can be used as a processing gas 181 or 281, injected with a flow rate (Q). The power supply voltage level V and flow rate Q can be control parameters for both reactors. The reactors' chambers have diameter D 76.2 mm and height L 150 mm and a quartz section to allow optical access. The residence time Tres of the gas is therefore given by:

Tres=[Pi D² L]/[4 Q]

The mass of material 135 such as solid LDPE samples can be configured to have a fixed mass of 10 grams or other suitable value and are placed inside a quartz plate (such as retainer 155, 255) 55 mm in diameter and 15 mm in height. A quartz plate with the feedstock (mass of material 135, 235) can be fitted in a cylindrical aluminum holder (retainer 155, 255). The holder acts as the ground electrode for the transarc reactor, but it is electrically decoupled in the glidarc reactor.

Note that computational Fluid Dynamics (CFD) thermal-fluid models can be created to evaluate the effect of control parameters on the operation of the reactors. The models describe the plasma as a volumetric heat source approximated as a solid with 100% porosity (i.e., no inertial resistance to fluid transport) in chemical equilibrium (i.e., species composition and material properties are a function of the local temperature only). For the transarc reactor, the plasma 135 can be approximated as a rectangular cylinder of 1.6 mm diameter or other suitable shape connecting the tip of a respective powered electrode to the feedstock. Whereas for the glidarc reactor, the plasma volume is approximated as a truncated pyramid with a triangular cross-section 50 mm long approximately filling the inter-electrode space. Convective heat transfer boundary conditions, specified with an outside temperature of 300 degrees K and a convective heat transfer coefficient of 25 W/m²/K, are imposed over all the outer surfaces of the reactors.

Given a chemical equilibrium assumption, no chemical kinetics associated with the plasma or the interaction between the plasma and the feedstock are explicitly included in the models. Instead, the thermal-fluid models describe fluid flow and thermal characteristics throughout the reactors (reactor chamber, solid feedstock, and auxiliary components). Given the non-thermal nature of the generated plasma 125, 225 in the reactors, only a portion of consumed power is dissipated as heat. The amount of thermal power (dissipated heat) can be an input to the models. Therefore, the models can be configured to describe the operation of the reactors as a function of the control parameters inflow rate Q and thermal power dissipated by the plasma (assumed correlated with V).

Despite the high temperatures in the plasma volume, particularly for the transarc, the temperature near the reactors' walls is close to the ambient temperature of 300 K, irrespective of the amount of imposed thermal power. This suggests that the reactors can operate at or near room temperature without forced cooling.

### Operational Characteristics

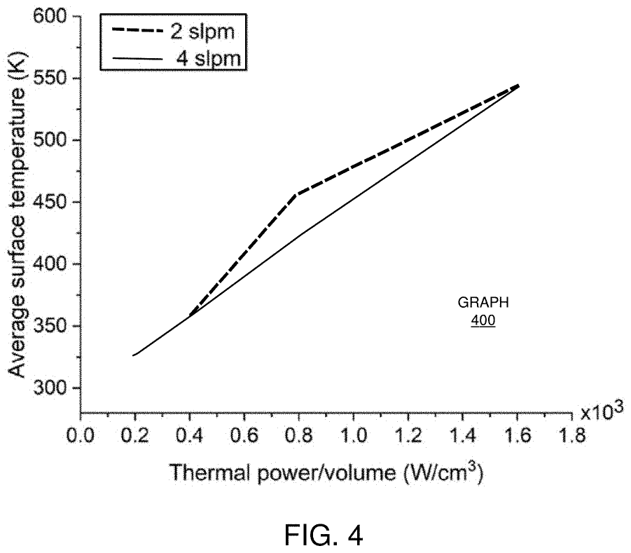

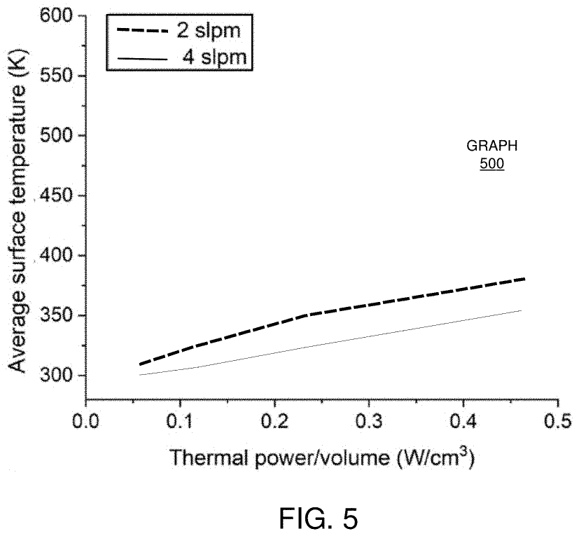

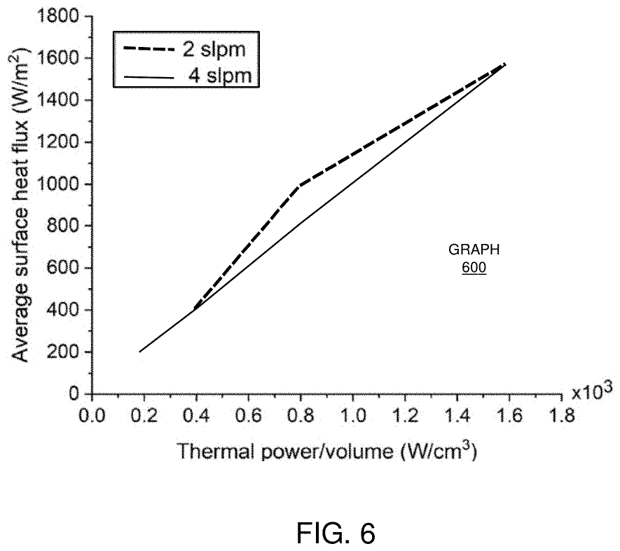

The expected operational characteristics of the reactors obtained with the thermal-fluid models as function of dissipated thermal power and flow rate are shown in FIGS. 4-7. For the transarc reactor, the average surface temperature increases linearly with dissipated thermal power per unit volume (FIG. 4) and has minimal dependence on flow rate. The small difference in the average surface temperature for the flow rate of 2 and 4 slpm at 800 W/cm³ is ascribed to the computational error of the simulation. The glidarc reactor's average surface temperature varies directly with dissipated thermal power, but inversely with flow rate, as shown in FIG. 5. A higher flow rate leads to enhanced convective cooling, which reduces the amount of heat deposited on the substrate. The average heat flux over the feedstock for both reactors (FIGS. 6 and 7) follows the same trends as the average surface temperature. These simulation results suggest that the transarc reactor can operate with small flow rates compared to those needed for the glidarc reactor, whose operation is very sensitive to flow rate. Based on these results, the experimental characterization of the reactors uses voltage level V (assumed proportional to thermal power dissipation) for both reactors, electrode-feedstock spacing H for the transarc reactor, and flow rate Q for the glidarc reactor, as main operational parameters.

The graph 400 in FIG. 4 is an example diagram of average surface temperature of the processes material versus dissipated thermal power for two values of flow rate associated with the system 100-1 (so-called reactor system) as described herein.

The graph 500 in FIG. 5 is an example diagram of average surface temperature of the processes material versus dissipated thermal power for two values of flow rate associated with the system 100-2 (such as reactor system) as described herein.

The graph 600 in FIG. 6 is an example diagram of average surface heat flux versus dissipated thermal power for two values of flow rate associated with the system 100-1 as described herein.

The graph 700 in FIG. 7 is an example diagram of average surface heat flux versus dissipated thermal power for two values of flow rate associated with the system 100-1 as described herein.

The graph 800 in FIG. 8 is an example diagram illustrating hydrogen gas production rate versus time for the system 100-1 as described herein when treating matter composed of different mass ratios of Low-Density Polyethylene (LDPE) and Cellulose (CE), from 100% low-density polyethylene (LDPE:CE=1:0) to 100% cellulose (LDPE:CE=0:1).

The graph 900 in FIG. 9 is an example diagram illustrating the efficiency of hydrogen gas production rate per unit power rate versus time for the system 100-1 as described herein when treating matter composed of different mass ratios of 1 Low-Density Polyethylene (LDPE) and Cellulose (CE), from 100% low-density polyethylene (LDPE:CE=1:0) to 100% cellulose (LDPE:CE=0:1).

The graph 1000 in FIG. 10 is an example diagram illustrating the average hydrogen gas production rate versus time for different mixture ratios of Low-Density Polyethylene (LDPE) versus Cellulose (CE) for the system 100-1 as discussed herein.

The graph 1100 in FIG. 11 is an example diagram illustrating the average efficiency of hydrogen gas production per energy input versus mixture ratio of Low-Density Polyethylene (LDPE) versus Cellulose (CE) for the system 100-2 as discussed herein.

FIG. 12 is an example block diagram of a computer system for implementing any of the operations as previously discussed according to embodiments herein.

Any of the resources (controller 140 such as controlling manufacturing equipment such as system 100-1, system 100-2, etc.) as discussed herein can be configured to include computer processor hardware and/or corresponding executable instructions to carry out the different operations as discussed herein.

As shown, computer system 1250 of the present example includes an interconnect 1211 coupling computer readable storage media 1212 such as a non-transitory type of media (which can be any suitable type of hardware storage medium in which digital information can be stored and retrieved), a processor 1213 (computer processor hardware), I/O interface 1214, and a communications interface 1217.

I/O interface(s) 1214 supports connectivity to repository 1280 and input resource 1292.

Computer readable storage medium 1212 can be any hardware storage device such as memory, optical storage, hard drive, floppy disk, etc. In one embodiment, the computer readable storage medium 1212 stores instructions and/or data.

As shown, computer readable storage media 1212 can be encoded with controller application 140-1 (e.g., including instructions) to carry out any of the operations as discussed herein.

During operation of one embodiment, processor 1213 accesses computer readable storage media 1212 via the use of interconnect 1211 in order to launch, run, execute, interpret or otherwise perform the instructions in image management application 140-1 stored on computer readable storage medium 1212. Execution of the image management application 140-1 produces image management process 140-2 to carry out any of the operations and/or processes as discussed herein.

Those skilled in the art will understand that the computer system 1250 can include other processes and/or software and hardware components, such as an operating system that controls allocation and use of hardware resources to execute image management application 140-1.

In accordance with different embodiments, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

Functionality supported by the different resources will now be discussed via flowcharts in FIG. 13. Note that the steps in the flowcharts below can be executed in any suitable order.

FIG. 13 is a flowchart 1300 illustrating an example method according to embodiments. Note that there will be some overlap with respect to concepts as discussed above.

In processing operation 1310, the system 100 (system 100-1 or system 100-2) produces a first voltage via a first voltage source. The first voltage is conveyed over a first electrode.

In processing operation 1320, via conveyance of the first voltage over the first electrode, the system 100 generate low-temperature plasma 125 or 225 applied to a mass of material 135. Presence of the low-temperature plasma causes release of gas from the mass of material 135.

Note again that techniques as discussed herein are well suited to generate gas via exposure of a mass of material to plasma. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. An apparatus comprising:
a first voltage source operative to produce a first voltage;
a first electrode operative to convey the first voltage; and
wherein the first voltage conveyed over the first electrode is operative to generate low-temperature plasma applied to a mass of material, presence of the low-temperature plasma releasing gas from the mass of material.

2. The apparatus as in claim 1 further comprising:
a second electrode operative to convey a reference voltage associated with the first voltage;
a retainer to retain the mass of material; and
wherein the second electrode conveys the reference voltage to the retainer.

3. The apparatus as in claim 1, wherein an axial end of the first electrode includes a pointed tip from which the low-temperature plasma extends from the pointed tip at the axial end of the first electrode to a surface of the mass material.

4. The apparatus as in claim 1, wherein the mass of material is a solid polymer material.

5. The apparatus as in claim 4, wherein the gas released from the mass material is hydrogen gas.

6. The apparatus as in claim 1 further comprising:
an airtight container in which the first electrode and the mass of material reside, the container containing the hydrogen gas.

7. The apparatus as in claim 6, wherein the airtight container includes an input port and an output port, the input port operative to input first gas into the airtight container, the output port operative to exhaust a second gas including the hydrogen gas from the airtight container.

8. The apparatus as in claim 1 further comprising:
a second voltage source operable to produce a second voltage;
a second electrode operative to convey the second voltage; and
wherein a combination of the first voltage conveyed over the first electrode and the second voltage conveyed over the second electrode are operative to generate the low-temperature plasma, the low-temperature plasma extending between at least the first electrode and the second electrode to the mass of material.

9. The apparatus as in claim 8 further comprising:
a nozzle operative to supply gas directed towards the low-temperature plasma, the supplied gas operative to contact the low-temperature plasma to a surface of the mass of material.

10. The apparatus as in claim 9 further comprising:
a third electrode operative to convey a reference voltage associated with the first voltage and the second voltage, the apparatus further comprising:
a retainer to retain the mass of material, the first electrode and the second electrode diverging from each other as axial ends of the first electrode and the second electrode become nearer to the mass of material.

11. The apparatus as in claim 10 further comprising:
a container in which the first electrode, the second electrode and the mass of material reside, the container containing the gas released from the mass of material.

12. The apparatus as in claim 11, wherein container includes an input port and an output port, the input port operative to input first gas into the container, the output port operative to exhaust a second gas from the container;
wherein the second gas includes a combination of the first gas and the gas released from the mass of material.

13. A method comprising:
producing a first voltage via a first voltage source, the first voltage conveyed over a first electrode; and
via conveyance of the first voltage over the first electrode, generating low-temperature plasma applied to a mass of material, presence of the low-temperature plasma releasing gas from the mass of material.

14. The method as in claim 13 further comprising:
via a retainer, retaining the mass of material; and
applying a reference voltage over a second electrode to the retainer, the reference voltage being a return path associated with the first voltage.

15. The method as in claim 13, wherein an axial end of the first electrode includes a pointed tip from which the low-temperature plasma extends from the pointed tip at the axial end of the first electrode to a surface of the mass of material.

16. The method as in claim 13 further comprising:
containing the gas in a container in which the first electrode and the mass of material reside.

17. The method as in claim 16, wherein the gas released from the mass of material is a first gas;
wherein the container includes an input port and an output port, the method further comprising:
via the input port, inputting a second gas into the container;
via the output port, exhausting a third gas from the container, the third gas including the first gas in the second gas.

18. The method as in claim 13 further comprising:
via a second voltage source, producing a second voltage;
via a second electrode, conveying the second voltage; and
generating the low-temperature plasma via a combination of the first voltage conveyed over the first electrode and the second voltage conveyed over the second electrode, the low-temperature plasma extending between at least the first electrode and the second electrode to the mass of material.

19. The method as in claim 18, wherein the gas released from the mass material is a first gas, the method further comprising:
via a nozzle, supplying second gas directed towards the low-temperature plasma, the supplied second gas causing the low-temperature plasma to contact a surface of the mass of material.

20. The method as in claim 18 further comprising:
via a third electrode, conveying a reference voltage associated with the first voltage and the second voltage; and
via a retainer, retaining the mass of material; and
wherein the first electrode, the second electrode, and the third electrode diverge from each other as axial ends of the first electrode, the second electrode, and the third electrode become nearer to the mass of material.

21. The apparatus as in claim 1, wherein the mass of material includes a non-homogenous mixture of a first type of material and a second type of material.

22. A mass of material exposed to low temperature plasma.

23. The mass of material as in claim 22, wherein the mass of material comprises plastic.

24. The mass of material as in claim 22, wherein the mass of material comprises organic matter.

25. The mass of material as in claim 22, wherein the mass of material comprises plastic and organic matter.
